(19) United States
(12) Patent Application Publication
(10) Pub. No.: US 2023/0401600 A1
(43) Pub. Date: Dec. 14, 2023

(54) SYSTEM AND METHOD FOR BUILDING A CAMPAIGN QUEUE WITH CONTEXTUALIZATION

(71) Applicant: FANATICAL, INC., Los Angeles, CA (US)

(72) Inventors: Garrett LAW, LOS ANGELES, CA (US); Tyson LAW, LOS ANGELES, CA (US); Josh McHUGH, LOS ANGELES, CA (US)

(73) Assignee: FANATICAL, INC., Los Angeles, CA (US)

(21) Appl. No.: 18/208,097

(22) Filed: Jun. 9, 2023

Related U.S. Application Data
(63) Continuation-in-part of application No. 14/586,455, filed on Dec. 30, 2014, now abandoned.

(51) Int. Cl. G06Q 30/0242; G06Q 30/0251

(52) U.S. Cl. CPC G06Q 30/0244; G06Q 30/0254

(57) ABSTRACT

A system for building a messaging campaign queue with contextualization includes a processor, an interactive display, and a memory module. The memory module includes stored computer-executable program code that, along with the memory module and the processor is configured to carry out a number of operations to create and customize a set of campaign interactions. One such operation involves creating a campaign queue based on a campaign type and a set of campaign parameters. The campaign queue includes a set of campaign interactions, each of which is associated with an intended recipient. Another such operation involves providing, via the interactive display, interaction context associated with the campaign interactions. An additional operation involves customizing the campaign interactions based on customization input received via the interactive display.

### RELATED APPLICATIONS

This application is a continuation-in-part of U.S. patent application Ser. No. 14/586,455 filed on Dec. 30, 2014, the contents of which are incorporated herein by reference in its, entirety.

### TECHNICAL FIELD

The present disclosure relates generally to computing devices used for data tracking and analytics and to social media marketing platforms that use such devices, and more particularly to systems and methods for building a campaign queue with contextualization.

### BACKGROUND

Conventional computing solutions for social media marketing platforms generally enable only a broad and generic targeting of users that is not individualized, except for on a very small scale. For example, conventional solutions for brand marketing may allow for a broad engagement with a large audience, or for a targeted engagement with a small audience.

With the recent explosion in social media's popularity, however, has come the ability for individuals to interact with brands in a one-on-one fashion. This ability has introduced new problems for existing social media and online marketing solutions. To illustrate, one issue with conventional social media marketing platforms is that they do not enable individualized interactions with users on a larger scale. Responding to or engaging in thousands of individual interactions per week is not feasible using existing solutions, and particularly not if the interactions are to be personalized, systematic, and contextual. This is because, to individualize social media interactions on a large scale using existing platforms requires a brute-force approach that is time consuming and inaccurate (e.g., manually processing, managing, and tracking massive amounts of data). This brute-force approach not only fails to achieve an effective level of personalization, it also tends to result in duplicative efforts (leading to recipient annoyance). These failings cause problems because accuracy and personalization may be particularly important when engaging influential recipients and when doing so publicly.

Additional issues with existing solutions for online marketing, such as customer relationship management (CRM) tools and publishing and engagement tools, is that they are geared toward only responsive-not proactive-interactions with users (e.g., identifying/cataloging a discussion about a brand). Moreover, these existing solutions lack information and insight about relevant context and individual recipients' relationships with a brand or related brands (e.g., based on past interactions with/regarding the brand), do not allow for systematic messaging campaigns, are not well-suited to crafting personalized interactions, do not allow for tracking/analyzing results or performance of a marketing campaign, and are not customizable or amenable to scheduling (and particularly not on the fly) based on a particular goal for the marketing campaign. As such, these conventional solutions also require a brute-force approach that is not only clunky and slow, but is also prone to error and lacks the availability of information key to building compelling interactions with targeted recipients. To the extent such key information and individualized insight may be gleaned using conventional solutions, the process of doing so is manual—not automated—and requires mining information from disparate sources, and is thus overly time consuming.

Some conventional email marketing platforms are geared to more proactive campaigns and allow for some basic customization and personalization, but these platforms are effective only for either a small variety of messages sent in bulk (and typically all sent at once) or a smaller number of messages with a larger variety of content. As such, these platforms do not offer the ability or opportunity to personalize user/brand interactions on a large scale and with a level of customization that provides for effective marketing/interaction. In short, conventional solutions do not provide an effective platform for social media or online marketing, including building and engaging with audiences (e.g., on behalf of brands).

### BRIEF SUMMARY OF THE DISCLOSURE

In view of the above drawbacks with conventional solutions, there exists a long-felt need for computing solutions and devices for social media and online marketing platforms that enable and facilitate strategic, proactive, personalized, precise, systematic, organized, and contextualized interactions with individual recipients on a large and dynamic scale. Further, there is a need for such devices that track, process, and organize large amounts of data regarding such interactions, and that provide distilled, useful metrics based on that data. Additionally, there is a need for devices that use such metrics to synthesize actionable and relevant information about recipients' previous responses to marketing interactions, and that integrate that information into the process and strategy of building and deploying individualized interactions going forward.

Embodiments of the present disclosure provide systems, methods, and apparatus for building campaign queues with contextualization. The disclosed embodiments enable proactive, targeted, and systematic interaction with a large number of individual recipients—for example, through social media channels. Moreover, the present disclosure includes a platform that streamlines, tracks, and organizes large amounts of relevant data to provide important context for such interaction, and that facilitates the integration of this data and context into the process of building customized interactions (e.g., by way of campaign queues). Embodiments of the present disclosure also process contextual data to provide guidance regarding campaign queue strategies that are most likely to be effective.

According to one embodiment of the disclosure, an apparatus for creating and updating a campaign queue containing a set of campaign interactions includes a campaign selection module that selects a campaign type for the campaign queue. The apparatus also includes a campaign setup module that receives and processes a set of campaign setup parameters. Further, the apparatus includes a customization module that creates a set of campaign interactions based on the campaign type and the campaign setup parameters. Each of the campaign interactions is associated with an intended recipient, and the customization module also updates one or more of the campaign interactions based on a set of customization parameters.

The customization parameters may include content of the campaign interaction, timing associated with deployment of the campaign interaction, method for prioritizing messaging order, and a template for the campaign interaction. The customization module, in one instance, receives the set of customization parameters by way of a graphical user interface that presents a customization window for each of the campaign interactions. In one example implementation, based on a disposition input received via the customization window, the customization module approves the campaign interaction for deployment to the intended recipient, saves the campaign interaction, or removes the intended recipient from the campaign queue.

In one embodiment of the apparatus, each of the campaign interactions includes a campaign message, and apparatus also includes a messaging setup module that selects one or more templates for each of the campaign interactions. In a variation of this embodiment, for each of the campaign interactions, the messaging setup module suggests one of the templates based on the intended recipient associated with the campaign interaction. Existing templates may also be edited. Moreover, in another implementation, templates may be added and called up for later use. In another variation, the apparatus also includes an interaction deployment module that transmits the campaign interactions to the intended recipients. Before the interaction deployment module transmits the campaign interactions, the messaging setup module solicits user input and updates one or more of the campaign messages based on the user input.

Another aspect of the present disclosure involves a method for creating and updating campaign interactions. The method includes receiving and processing a set of campaign setup parameters. The method also includes creating a campaign interaction based on one or more of a campaign type, a campaign goal, a campaign strategy, and the set of campaign setup parameters. In one embodiment, the set of campaign setup parameters includes a target segment and a campaign size. In another embodiment, the set of campaign parameters includes campaign metadata. The campaign interaction corresponds to (e.g., is to be deployed to) one or more intended recipients. The campaign interaction may include a campaign message containing a text entry field and one or more tokens.

Furthermore, the method for creating and updating campaign interactions includes updating the campaign interaction based customization input specific to one or more of the intended recipients that correspond to the campaign interaction. In one example implementation, the campaign interaction includes a campaign message, and creating the campaign interaction includes selecting one of a set of campaign message templates. A variation of this implementation includes suggesting one or more of the campaign message templates based on interaction context associated with the one or more intended recipients. Templates may be used in a similar fashion for creating and updating campaign interactions other than campaign messages (e.g., wall-posts, comments, and so on, as described in detail below).

In some embodiments, based on one or more campaign setup parameters, the message template may be used by a machine learning algorithm or model to provide variations of the same message said in different ways with the same meaning, and incorporate elements of the user's profile.

In some embodiments, a campaign may be optimized with respect to the selected goal by prioritizing the user selection and/or order based on conversion data and campaign settings.

In some embodiments, this may be accomplished by providing the machine learning algorithm with previous campaign data sets upon which it is trained. For example, historical data, comprised of campaign parameters, recipient data and message data, may be combined with result/conversion data to model patterns, add predictions and suggest highest-probability messages in queue for each recipient.

The machine learning algorithm may use the data stored on the server. When a campaign completes, the machine learning algorithm is used on the conversion data to evaluate which messages have been converted and which were not.

In some embodiments, various historical data may be used by the machine learning algorithm when determining one or more parameters that contributed to the success of the campaign. For example, message linguistic content, message length, message format, timing, and recipient biometric information may be evaluated against each other, on an individual, campaign, audience and system-wide levels.

In some embodiments, data related to the recipient and message interaction may be utilized. For example, time, interaction history (e.g., time period of recipient being a follower, time period between engagement), engagement and relationship data, recipient activity data (e.g., how busy is a particular recipient at the time of receipt of message) and similar such data may be used. This data may be obtained and reordered on each level and stored as historical data. When a new campaign is created, and the prioritization or customization machine learning algorithm is used, the components of the new message are evaluated vis-a-vis the stored historical data to date, and the system alongside each message will display options or update to optimize based on updating to maximize effectiveness (for systemwide, audience, campaign and individual).

One embodiment of the method includes displaying the campaign interaction such that the campaign interaction may be updated and approved via a graphical user interface, and deploying the campaign interaction only after the campaign interaction is approved. Displaying the campaign interaction may entail displaying interaction context associated with the one or more intended recipients. The interaction context, in one instance, includes profile information, interaction history, and relationship analytics related to the intended recipient. Furthermore, recommendations for improving the message may be generated. For example, the recommendations or suggestions may be mad by the machine learning algorithm. The recommendations can include the suggested action along with the estimated percentage (or relative, low-high numeric value) improvement in effectiveness.

An additional aspect of the present disclosure includes a system for building a messaging campaign queue with contextualization. The system includes a processor, an interactive display, and a memory module. The memory module includes stored computer-executable program code. The memory module, the stored computer-executable program code, and the processor, are configured to create a campaign queue based on a campaign type and a set of campaign parameters. In one embodiment of the system, the set of campaign parameters includes a campaign goal and a campaign strategy, and the memory module, the stored computer-executable program code, and the processor are configured to provide a suggestion for one of the campaign goal and the campaign strategy based on the campaign type.

The campaign queue includes a set of campaign interactions, each of which is associated with an intended recipient. In an example implementation of the system, the memory module, the stored computer-executable program code, and the processor are configured to, for each of the one or more campaign interactions, receive an instruction via the interactive display. The instruction received may be to deploy the campaign interaction to the intended recipient, to save the campaign interaction, or to delete the campaign interaction from the campaign queue.

Moreover, the memory module, the stored computer-executable program code, and the processor, are configured to provide, via the interactive display, interaction context associated with one or more of the campaign interactions. The memory module, the stored computer-executable program code, and the processor, are further configured to customize one or more of the campaign interactions based on customization input received via the interactive display. In one embodiment, the customization input includes modifications to the campaign parameters, modifications to content of one or more of the campaign interactions, and modifications to deployment timing for one or more of the campaign interactions.

### BRIEF DESCRIPTION OF THE DRAWINGS

FIG. 1 illustrates an example system configured to generate contextualized campaigns, according to an implementation of the disclosure.

FIG. 2 illustrates an example campaign management server of the example system illustrated in FIG. 1, according to an implementation of the disclosure.

FIG. 3 illustrates an example computing system that may be used in implementing various features of embodiments of the disclosed technology.

The figures are provided for purposes of illustration only and merely depict typical or example embodiments of the disclosure. The figures are described in greater detail in the description and examples below, and are not intended to be exhaustive or to limit the disclosure to the precise form disclosed. It should be understood that the disclosure may be practiced with modification or alteration, and that the disclosure may be limited only by the claims and the equivalents thereof.

### DETAILED DESCRIPTION

The present disclosure is directed to various embodiments of systems, methods, and apparatus for building campaign queues with contextualization. The details of some example embodiments of the systems, methods, and apparatus of the present disclosure are set forth in the description below. Other features, objects, and advantages of the disclosure will be apparent to one of skill in the art upon examination of the present description, figures, examples, and claims. It is intended that all such additional systems, methods, features, and advantages, etc., including modifications thereto, be included within this description, be within the scope of the present disclosure, and be protected by one or more of the accompanying claims.

Various embodiments of the disclosed systems, methods, and apparatus for building campaign queues with contextualization include, in various instances, generating a campaign queue which includes a set of campaign individualized interactions for a large group of recipients intended to satisfy the campaign goal (e.g., increase brand awareness). The individualized interactions may be generated within the context of the campaign type and/or strategy. That is, the campaign type and/or strategy may each be determined based on the campaign goal which may be provided by the user or suggested by system. The individualized interactions may include generating individualized messages customized for each recipient using natural language within the context of previous user interaction data (e.g., historical data of user's interacting with a brand) and other user information (e.g., user's biometric data, interest data, age, and so on.)

In various embodiments, the disclosed systems, methods, and apparatus are implemented in a computing environment using one or more computing devices. Such computing devices may be configured to be convenient for interactive interfacing applications, for example, to capture a user's input regarding campaign queues and interactions, and/or to display options or analysis regarding the same. Other applications of the disclosed embodiments and configurations thereof will be apparent to one of skill in the art upon examining the present disclosure.

Before going into a detailed description of the various embodiments of the systems, methods, and apparatus of the present disclosure, a high-level description of the process of building campaign queues with contextualization, including campaign queues made up of series of campaign interactions, will be provided. In light of the context provided by this high-level description, the details of the disclosed systems, methods, and apparatus, as well as variations thereon and modifications thereto (both of which are included within the scope of the present disclosure), will become more clear to one of skill in the art.

At a high level, automatically building marketing campaign queues, i.e., marketing campaigns, before they are sent to recipients, with a high level of contextualization includes generating a series of campaign interactions. A campaign interaction is an outgoing action toward one or more intended recipients intended to promote a business. For example, a campaign interaction can include subscribing to a recipient's social media feed, sending a direct message or email to a recipient, liking or favoriting a recipient's specific post, calling or sending an SMS message.

Further, building campaign queues may entail a number of phases or stages that a user/creator proceeds through, typically leading up to deploying campaign interactions to intended recipients. The user or creator, as referred to herein, may be a user of social media (e.g., an individual or a business entity/brand) or other online marketing mechanism (e.g., email, web pages, etc.), or may be an advertising agency acting on behalf of a brand. Generally, the user/creator of a campaign queue may be anyone with the desire to engage others through communications channels including email or the Internet, telephone, direct mail, and/or through social media channels.

Additionally, users can also create universally available campaign types available to all brands and users, in which the Administrators set default parameters like interaction types and default inputs like text, links etc. Example universal campaign types include but are not limited to, new product introduction, user survey, voting reminder, event invitation, etc. In addition to the default parameters set by the administrator, they can also use Al algorithms based on previous campaign data, to optimize the campaign queue for that particular brand. For example, they can first suggest interacting with users most likely to interact, can set message send times optimized for likely interaction, etc.

In some embodiments, the four stages of building a campaign queue may include a campaign selection stage, a campaign setup stage, a campaign interaction setup stage, and a customization stage.

For example, the campaign selection stage, which may be the first stage, may involve the user selecting a campaign goal. Based on the campaign goal, the system recommends campaign strategy and types of campaign to fulfill those strategies. Campaign types are associated with specific types of actions on each platform. The campaign goal typically expresses the ultimate goal of the campaign, while the campaign strategy typically includes means or mechanism for achieving the campaign goal. The campaign type may depend on a particular social media platform the campaign is being designed for, though campaigns may be designed for implementation across multiple platforms.

The campaign type may, for instance, be a messaging campaign, an audience-building campaign, a brand-awareness campaign, and the like. For each campaign type, the user may customize or define the campaign in terms of a campaign goal and a campaign strategy.

Another high-level example stage for building campaign queues with contextualization is the campaign setup stage, which may be the second stage. This stage may involve, by way of illustration, one or more of selecting a group of intended recipients for the campaign, adding metadata to the campaign, specifying a campaign start and end date, specifying a social media account to associate with the campaign, specifying a size of the campaign (e.g., number of interactions to deploy/attempt), and specifying additional variables/constraints (e.g., time zone). In short, this stage may typically involve a number of front-end customization decisions and options used to build the campaign queue, though these decisions may be revisited and modified later on as well. Additional aspects of this stage will be further clarified and expounded upon in the description below.

A further illustrative stage, which may be the third stage in building campaign queues with contextualization, is the campaign interaction setup stage. In some example implementations, campaign interactions include an aspect of “conversation” or online communication with intended recipients, including (for example) publicly or privately writing or commenting on something intended recipients have done. The campaign interaction may entail, by way of example, initiating a message, wall post, tweet, email, chat, or the like. As such, setting up the campaign interaction may include using one or more templates (e.g., a message template) into which text and other content may be entered. The template may provide an initial starting point from the campaign interaction, which may be modified/customized later on. Additional aspects of this stage will be further clarified and expounded upon in the description below.

An additional example stage for building campaign queues with contextualization is customization stage, which may be the fourth stage. At this stage, the information received in the other three stages may be associated with each of the intended recipients to create a series of individualized campaign interactions. The series of campaign interactions may also be provided to the user in graphical format such that the user can process and/or revise/customize each campaign interaction in the campaign. Further, this stage may involve providing the user with relevant and multifaceted contextual data for each campaign interaction, such that the user may further customize, modify, and tailor each campaign interaction, as will be further described below.

After passing through these four stages, the user may approve the campaign queue or one or more campaign interactions for deployment (e.g., to the intended recipients), save campaign interactions for further review, or take other, informed actions, as the user deems necessary (e.g., remove intended recipients from campaign queues, etc.). Campaign interactions that are approved for deployment may then be processed and deployed to the intended recipients, and may be tracked and integrated back into the system models and analysis actionable to users in building future/ongoing campaigns.

Together, the above-described stages of building campaign queues with contextualization, including creating and updating a campaign queue that contains campaign interactions, allow for construction and execution of a “one-to-many” campaign, in which campaign interactions are individualized to recipients in a systematic way. The result is a campaign queue (e.g., including a scalable number of campaign interactions) with contextualization that integrates empirical intelligence—whether collected manually by an individual or automatically through computing means—and is more effective, streamlined, and conveniently managed, and that is deployable to a large number of recipients and across multiple platforms. In the context of the above-described stages, a detailed description of the various figures of the present disclosure is provided, as follows.

### System

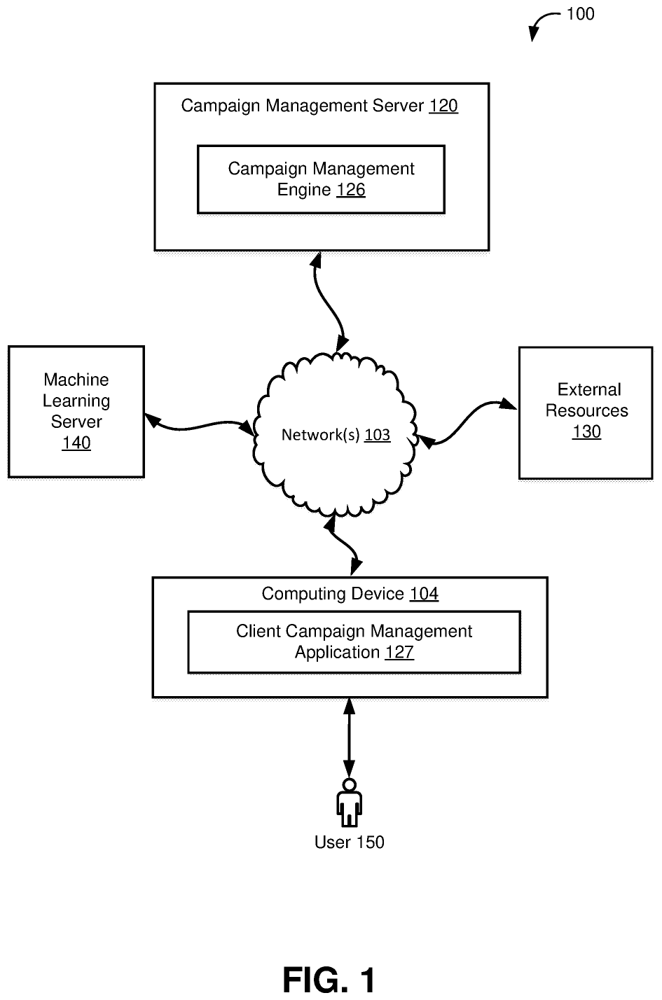

FIG. 1 is a schematic block diagram illustrating an example implementation of system 100 for managing campaign queue, including generating campaign interactions, that has a high likelihood of success. System 100 includes a campaign management server 120 for creating and updating a campaign queue, a network 103, a machine learning server 140, external resources 130, and a computing device 104. A user 150 may be associated with client computing device 104 as described in detail below.

Embodiments of system 100 are capable of building campaign queues with contextualization, including, for example, enabling proactive, targeted, and systematic interaction with a large number of individuals, as well as convenient, organized tracking of the same. Moreover, embodiments of system 100 allow for creating and updating an individualized campaign queue by basing a set of campaign interactions on a set of customizable campaign setup parameters. Additionally, embodiments of system 100 update the campaign interactions based on a set of customization parameters. This updating feature allows system 100, in various embodiments, to build recipient-specific interactions tailored to intended recipients based on relevant contextualization information, including previous interaction content, timing, and/or structures, that have been determined to be effective.

An additional aspect of system 100 includes tailoring/updating the campaign interactions before deployment to the intended recipients. Being recipient-specific and easily/effectively customizable, the campaign queue and campaign interactions created and updated by system 100 may be targeted, so as to be more likely to get traction with or lead to conversion of intended recipients, while also being scalable to a large number of intended recipients, including across multiple marketing or other platforms (e.g., social media and Internet platforms) and channels. Such targeted, yet scalable campaign queues may be more effective in terms of driving a brand's traction and influence with recipients, for example, not only because the campaign interactions thereof are customized, but also because tracked and organized information regarding previous interactions with recipients may be conveniently incorporated into the campaign queues.

In some embodiments, campaign management server 120 may include a processor, a memory, and network communication capabilities. In some embodiments, campaign management server 120 may be a hardware server. In some implementation, campaign management server 120 may be provided in a virtualized environment, e.g., campaign management server 120 may be a virtual machine that is executed on a hardware server that may include one or more other virtual machines. Campaign management server 120 may be communicatively coupled to network 103. In some embodiments, campaign management server 120 may transmit and receive information to and from one or more of client computing devices 104, machine learning server 140, external resources 130, and/or other servers via network 103.

In some embodiments, as alluded to above, campaign management server 120 may include a distributed campaign management engine 126 and a corresponding client campaign management application 127 running on one or more client computing devices 104.

In some embodiments, users of coverage recommendation system 100 (e.g., business owners) may access the campaign management engine 126 via client computing device(s) 104. In some embodiments, the various below-described components of FIG. 1 may be used to initiate campaign management application 127 within client computing device 104. In some embodiments, campaign management application 127 may be configured to obtain information related to the campaign goal entered by user 150 and display campaign type recommendations determined by campaign management engine 126. In some embodiments, business owners may be required to provide various information related to campaign messaging, as described in further detail below.

In some embodiments, machine learning server 140 and/or other components of lead distribution system 100 may be configured to use machine learning, e.g., use a machine learning model that utilizes machine learning to determine campaign type classification and a corresponding campaign type classification. In some embodiments, machine learning may be used to determine a likelihood of a success of each campaign type based on the historical interaction information and goal classification, as described in further detail below. In some embodiments, machine learning server 140 may include one or more processors and memory and network communication capabilities. In some embodiments, machine learning server 140 may be a hardware server connected to network 103, using wired connections, such as Ethernet, coaxial cable, fiber-optic cable, etc., or wireless connections, such as Wi-Fi, Bluetooth, or other wireless technology. In some embodiments, machine learning server 140 may transmit data between one or more of campaign management server 120, client computing device 104, external resources 130, and/or other components via network 103.

In some embodiments, external resources 130 may comprise one or more of social media platforms provided by one or more social media systems. In some embodiments, external resources platforms may include one or more servers, processors, and/or databases that can store recipient information, interaction information, historical interaction information, and other such information provided by one or more external systems resources 130. For example, contextual information and user interaction history may be used by campaign management engine 126 when determining campaign type recommendations, as will be further described in detail below.

In some embodiments, campaign management engine 126 may communicate and interface with a framework implemented by external resources 130 using an application program interface (API) that provides a set of predefined protocols and other tools to enable the communication. For example, the API can be used to communicate particular data from an insurance carrier used to connect to and synchronize with campaign management engine 126.

In some embodiments, client computing device 104 may include a variety of electronic computing devices, such as, for example, a smartphone, tablet, laptop, computer, wearable device, television, virtual reality device, augmented reality device, displays, connected home device, Internet of Things (IOT) device, an enhanced general packet radio service (EGPRS) mobile phone, a media player, a navigation device, a game console, a television, a remote control, or a combination of any two or more of these data processing devices, and/or other devices. In some embodiments, client computing device 104 may present content to a user and receive user input. In some embodiments, client computing device 104 may parse, classify, and otherwise process user input. For example, client computing device 104 may store user input associated with an agent claiming or selecting a lead, as will be described in detail below.

### Campaign Management

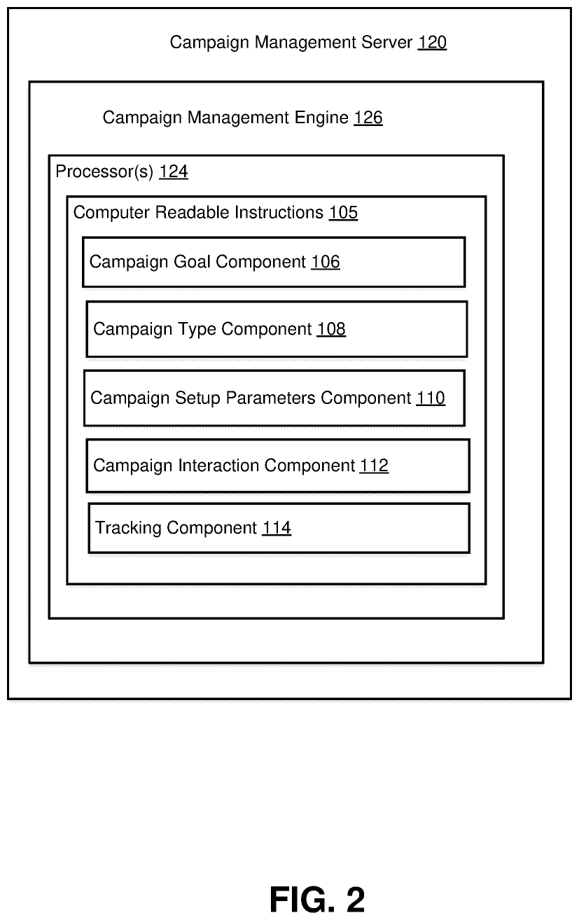

FIG. 2 illustrates an example campaign management server 120 of system 100 illustrated in FIG. 1 configured in accordance with one embodiment. In some embodiments, the various below-described components of FIG. 2 may be used to generate campaign interactions based on a specific campaign goal, as described herein.

In some embodiments, campaign management server 120 may include campaign management engine 126, as alluded to above. In some embodiments, campaign management 126 may be operable by one or more processor(s) 124 configured to execute one or more computer readable instructions 105 of one or more computer program components. In some embodiments, the computer program components may include one or more of a campaign goal component 106, a campaign type component 108, a campaign setup parameters component 110, a campaign interaction component 112, a tracking component 114, and/or other such components.

### Campaign Goal

In some embodiments, a user may provide a campaign goal. As discussed above, the campaign goal may express the ultimate goal of the campaign, e.g., growing the number of fans for a brand, increasing brand awareness, promoting content, and so on. The goal may be selected from a set of pre-programmed options or entered as a natural language (NRL) command. For example, user may enter “promotion of YouTube content” into a graphical user interface of the application as a campaign goal. In some embodiments, user provided campaign goal may be processed by campaign goal component 106. In other embodiments, the system may generate the goal based on previously generated campaigns or, alternatively, based on the information associated with the brand itself (e.g., insufficient social media exposure and so on).

In some embodiments, user may provide campaign goal metric/quantity. For example, user may provide a type of actions (e.g., email messages) and the frequency of these actions.

More specifically, the goal would include a type and hoped for number of interaction/response/engagement/results, and the system would create/customize the campaign type and queue to meet that. Or it would continue the campaign until it is met.

### Campaign Type(s)

Upon receiving the campaign goal from campaign goal component 106, a campaign type may be determined. Generally, the campaign type may be associated with an online marketing or promotion (including for social purposes) platform and may include a campaign and associated interactions executed via one or more social media platforms. For example, the campaign type may be a video campaign through YouTube®, may be a Twitter® campaign to increase friends/followers, may include promoting a YouTube® video through Facebook®, and so on. In some embodiments, campaign type component 108 may determine at least one campaign type recommendation for achieving user specified goal. It may be suggested that the user post on a particular topic (e.g., a topic related to the brand or a topic of interest to the desired fan base).

In some embodiments, the campaign type recommendations may be based on applying one or more proprietary algorithms (e.g., machine learning algorithms) to determine the type of the campaign to achieve the campaign goal specified by the user with the highest likelihood of success. In other embodiments, the quantity and type of actions needed to achieve that goal may be taken into consideration when determining the campaign type.

### Campaign Strategy

In some embodiments, campaign type may be determined in terms of a campaign strategy. The campaign strategy may be thought of in terms of the means for achieving/executing the campaign goal. For example, if the campaign goal is to promote content (e.g., YouTube® video content), the campaign strategy may include getting wall-posts/shares of the video content, getting a certain number of views/“likes” of the video content, etc. For a given strategy, multiple campaigns types may be suggested that each can contribute toward the goal. For example, getting visits to a website may include one campaign deployment on Twitter, one via email, and another via SMS, each with a goal of Link Clicks. Results from each campaign type will contribute toward the goal.

To illustrate, the campaign goal may include growing the number of fans for a brand—as part of the campaign strategy, it may be suggested that the user post on a particular topic (e.g., a topic related to the brand or a topic of interest to the desired fan base). In other words, the campaign strategy includes one or more action items to be executed in furtherance of effectively achieving the selected campaign goal.

In some embodiments, campaign type component 108 may determine a type for the campaign goal and the campaign strategy that is most effective based on applying machine learning algorithms to trained on historical data of type/goal/strategy combinations in previous campaigns and/or based on normative data, as discussed further below.

### Machine Learning

In some embodiments, campaign type component 108, may be configured to use machine learning, i.e., a machine learning model that utilizes machine learning to determine the campaign strategy based on user input of campaign goal. For example, in a training stage campaign type component 108 (or other component) may be trained using training data (e.g., campaign goal, campaign strategy, campaign type, and campaign success data) or actual campaign goal, campaign strategy, campaign type, and campaign success in a classification determination context, and then at an inference stage can determine classification. For example, the machine learning model can be trained using synthetic data, e.g., data that is automatically generated by a computer, with no use of user information.

In some embodiments, campaign type component 108, may be configured to use machine learning to determine one or more campaign types to fulfil the campaign strategy determined to fulfil the campaign goal, as alluded to above.

In some embodiments, campaign type component 108 may be configured to use one or more of a deep learning model, a logistic regression model, a Long Short Term Memory (LSTM) network, supervised or unsupervised model, etc. In some embodiments, campaign type component 108 may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

In some embodiments campaign type component 108 may be configured to determine one or more campaign types associated with the campaign strategy by determining a likelihood of success. The success of a campaign type may be evaluated using metrics data (e.g., provided by the social media platform), conversion rate data (e.g., achievement of or progress toward the campaign goal) and/or other measurable occurrences. For example, individual engagement metrics such as likes, comments, retweets, may be used to quantify success of the complain of a particular type. Similarly, post-engagement rate, i.e., the number of engagements divided by impressions or reach may be used. Finally, organic accounts mentions may be used to evaluate brand awareness.

In some embodiments, when determining a likelihood of success, campaign type component 108 may utilize business information including, business type or industry type, types of services or goods provided, target recipient demographics, and other such information. For example, target recipient historical activity data, voter records, product or service pricing data.

In some embodiments, campaign type component 108 may be configured to determine the campaign type and the likelihood of success using a number of models or methods. For example, Bayesian-type statistical analysis may be used during the likelihood of success determination.

In some embodiments, a likelihood of success for each campaign type may be expressed as a success score. For example, a success score may be expressed on a sliding scale of percentage values (e.g., 10 percent, 15 percent, . . . n, where a percentage may reflect likelihood of campaign success), numerical values (e.g., 1, 2, . . . n, where a number may be assigned as low and/or high), verbal levels (e.g., very low, low, medium, high, very high, and/or other verbal levels), and/or any other scheme to represent a success score. For example, campaign type component 108 may determine that to in order to increase brand awareness, a video campaign through YouTube may have a sixty percent likelihood of success, whereas a Twitter® campaign to increase friends/followers may only have a thirty percent likelihood of success.

In some embodiments, campaign type component 108 may be configured to generate one or more campaign type recommendations based on campaign types and their associated determinations of likelihood of success. Next, the user may select the campaign type from a set of presented campaign type recommendations generated by campaign type component 108. Alternatively, campaign type component 108 may be configured to automatically select the campaign type with the highest likelihood of success.

### Setup Parameters

Upon receiving the campaign type selection from campaign type component 108, campaign setup parameters may be obtained by campaign setup parameters component 110. The campaign setup parameters may be pre-determined based on the type of campaign. Alternatively, the user can provide the parameter as user inputs based on pre-determined limits (e.g., set by system admins). For example, a pre-determined limit may include a maximum number of actions allowed per day per campaign. In some embodiments, campaign setup parameters may be determined by campaign setup parameters component 110. Limits may be based on platform maximums like API call limits, platform pricing limits, administrator-determined best practices (like a brand shouldn't contact someone more than X times per day/week/month using the system).

In some embodiments, the campaign setup parameters may include or define a target segment of intended recipients for one or more campaign interactions. The target segment may, by way of illustration, be a segment or group of “followers” (e.g., for Twitter®), a group of people who “like” a particular brand (e.g., for Facebook®, or may be defined based on geographical or other profile features, and the like. In some embodiments, the set of campaign setup parameters may be received and processed before the campaign strategy is suggested.

The campaign setup parameters may also include campaign metadata added to the campaign interactions that may aid for searching, tracking, sorting, and/or organizing campaign interactions. For example, such metadata may include a title for a set of campaign interactions, a description for a set of campaign interactions or a campaign, a creation date, the campaign type, the campaign goal, the campaign strategy, and so on. The campaign metadata may be added manually by the user, or may be added automatically (e.g., determined based on the campaign type, campaign strategy, campaign goal, or other of the campaign setup parameters).

Additionally, the campaign setup parameters may include a campaign size (e.g., total number of campaign interactions to create, or total campaign interactions to launch per time period), a campaign start and/or end date, a social media account to be associated with the campaign or from which to launch the campaign interactions, a time zone, and the like.

### Interactions

Next, based on the type and the setup parameters, campaign interaction component 112 may generate a set of campaign interactions for deployment in the campaign queue. For examples, the set of campaign interactions may be tailored to each of the intended recipients' specific characteristics, and may further streamline the process of providing/customizing/tailoring such campaign interactions.

In some embodiments, unless provided by the campaign setup parameters, campaign interaction component 112 may first determine intended segment recipients of the campaign in order to achieve the campaign goal (e.g., increase brand awareness) using the campaign type (e.g., get a certain number of views/“likes” of the video content) of the campaign strategy (e.g., deploy posts on a particular topic). Next, campaign interaction component 112 may apply associated parameters and campaign setup details, and enqueuing them for action.

Each generated campaign interaction may correspond to one or more intended recipients—in other words, each campaign interaction is created to ultimately be deployed to at least one particular intended recipient. In various instances of the above-described campaign types, the associated campaign actions typically include some form of “conversation”—e.g., online interaction involving communication with the intended recipient.

Finally, campaign interaction component 112 may determine a probable effectiveness score for each interaction within the set. The probable effectiveness score may be used to prioritize the deployment of these interactions. Additionally, this may include individualized historical data (e.g., whether they interacted last time, their average interaction rate, whether they are relatively active or inactive publicly, etc.) Campaign interaction component 112 may apply a proprietary scoring mechanism for each audience member, based on profile, contextual, system aggregated historical data, and audience data, for each type of action.

In some embodiments, campaign interaction component 112 may generate campaign interactions that include campaign metadata. Campaign metadata may include data corresponding to the number of campaign activities that are underway, the number of campaign activities that remain, goal data and progress data, predictive data, and other analyses based on the campaign parameters as a whole, or as specifically applicable to that recipient, and recent or previous activities of that campaign type related to that user.

### Interaction Examples

In one embodiment of the disclosure, the campaign interaction may include a campaign message. Such a campaign message may be, for example, an email message or a message sent through a social media platform (e.g., a private message). In other embodiments, the campaign interaction includes a wall-post (e.g., to another social media account or web page), a chat interaction, a tweet, an article, other shared content (e.g., video, photo, hyperlinks, and the like), following a person, profile, page, or topic, “liking” a post or other object, or generally writing (e.g., publicly or privately) to an intended recipient or commenting on something the intended recipient has done.

In other embodiments, the campaign interaction may include a script delivered to an intended recipient over the phone (by a user in a call center), a live conversation over the phone, a voicemail, and/or any similar spoken interaction. Similarly, another input could be behavioral/voice analysis, etc.

In another embodiment, the campaign interaction may include an email delivered to an intended recipient's email address, rather than via a social media platform Tracking incoming and outgoing emails.

In other embodiments, the campaign interaction may include an SMS delivered to a recipient phone or via a messaging app. Tracking and communicating via that platform.

In another embodiment, the campaign interaction may include Speech recognition could be one of the inputs, and conceivably, CG voice or dynamically generated static or motion graphics could be outputs, delivered by multiple of the pathways.

In other embodiments, the campaign interaction may include messages physically delivered to an intended recipient's physical address, like direct mail or even handwritten notes.

Finally, in some embodiments, the campaign interaction may include real-life activities, for example messages physically delivered face-to-face to an intended recipient, like door to knock on in a political campaign, and at what time, based on the various data sources, context, predictive algorithms.

### Customization

In some embodiments, individual campaign interactions determined by campaign interaction component 112 may be updated based on customization input. The customization input is specific to one or more of the intended recipients. Receiving the customization input may entail varying the content of the campaign interaction itself. By way of illustration, when the campaign interaction includes a campaign message, the campaign message may include a text entry field and one or more tokens or placeholders, e.g., for the insertion of a name, greeting, URL, user handle, location, previous interaction, or other information useful to individualize the campaign message before the campaign message is deployed to the intended recipient(s). In such an example, customization input may be input directly into the campaign message.

In other examples, the customization input may involve varying the structure of the campaign interaction. For campaign messages, this may be done by selecting one of a set of campaign message templates presented to the user as options (e.g., by displaying the various message templates, by a drop-down, etc.). In this manner, different templates may be selected depending on the characteristics of the intended recipients. In one embodiment, message templates are, as an initial matter, randomly assigned to intended recipients. As information about the intended recipients is learned/tracked, however, messaging templates may be assigned to the intended recipients systematically (e.g., based on conversion rates, interaction context, etc.). The customization input, in other instances, alternatively or in addition to being associated with structure/content of a campaign interaction, may include modifications to one or more of the campaign parameters and/or modifications to the deployment timing for one or more of the campaign interactions.

### Context

In some embodiments, campaign interaction component 112 may generate one or more campaign message template recommendations based on interaction context associated with the one or more intended recipients. For example, the interaction context may indicate that the intended recipient has previously responded positively to a particularly structured campaign message—e.g., a campaign message including a particular type of greeting, subject line, content, and so on.

In some embodiments, campaign context may be determined through an algorithmic mechanism that, while creating the campaign queue, and according to campaign type, processes user profile and activity and other campaign data in which the recipient was involved, analyzes that data through specific filters that are inherent to that type of campaign in the system, and the output of which is incorporated into the interaction generation.

In some embodiments, campaign context be used during campaign interaction generation. For example, by using that same process based on a campaign goal or strategy selection, to predict results or recommend strategy to the user, upon which data the user can complete campaign setup. In some embodiments, campaign interaction component 112 can use specific campaign strategy and analyze with intended recipients, to predict effectiveness or recommend quantity of activities to achieve a certain result.

Based on this previous positive response, the same or a similar template may be suggested for the present campaign message being set up for the same intended recipient. In other examples, the campaign message template may be suggested based on interaction context with recipients who are not the intended recipient but have commonalities with the intended recipient.

In some embodiments, campaign interaction component 112, may be configured to use machine learning, i.e., a machine learning model that utilizes machine learning to determine the campaign context for individual recipients for the purpose of generating campaign message templates based campaign goal, strategy, type, and recipient response. For example, in a training stage campaign interaction component 112 (or other component) may be trained using training data (e.g., campaign goal, campaign strategy, campaign type, campaign success data, and recipient response data) or actual campaign goal, campaign strategy, campaign type, campaign success, and recipient response data in a classification determination context, and then at an inference stage can determine classification. For example, the machine learning model can be trained using synthetic data, e.g., data that is automatically generated by a computer, with no use of user information.

In some embodiments, campaign interaction component 112, may be configured to use machine learning to determine one or more campaign messages templates for each recipient of the campaign.

In some embodiments, campaign interaction component 112 may be configured to use one or more of a deep learning model, a logistic regression model, a Long Short Term Memory (LSTM) network, supervised or unsupervised model, etc. In some embodiments, campaign interaction component 112 may utilize a trained machine learning classification model. For example, the machine learning may include, decision trees and forests, hidden Markov models, statistical models, cache language model, and/or other models. In some embodiments, the machine learning may be unsupervised, semi-supervised, and/or incorporate deep learning techniques.

An additional example of customization input includes interaction context. For instance, if the intended recipient has relevant previous interaction context, a particular blurb may be suggested based on that interaction context. This may entail reminding the intended recipient of the interaction context (e.g., noting that the intended recipient previously liked a page, commented on a post, etc.).

The interaction context may also include a relationship indicator relating to the strength/quality/nature of the relationship between the user/creator and the intended recipient. The relationship indicator may also be extracted from the relationship between any combination of a similar user/creator (e.g., similar brand) or the user creator, and the intended recipient or a similar intended recipient (e.g., recipient with a similar profile). For example, the relationship indicator may be a number proportional to the influence that the user/creator has over the intended recipient, and may be based on the intended recipient's profile data, social activity/media data, and content specific engagement data (e.g., what type of content the intended recipient is most likely to engage with or be interested in). The relationship indicator may provide insight into how much effort should be expended in customizing the campaign interaction to the particular intended recipient. For example, where an intended recipient has a weaker relationship indicator, steps may be taken to compensate for that weakness, including providing more of an explanation of why a particular campaign interaction would be of interest to the intended recipient. Alternatively, where an intended recipient has a stronger relationship indicator, the campaign interaction may be modified to remind the intended recipient of this strength, thus increasing the likelihood of conversion/traction.

The interaction context may also include a relationship indicator relating to the strength/quality/nature of the relationship between the user/creator and the intended recipient. The relationship indicator may also be extracted from the relationship between any combination of a similar user/creator (e.g., similar brand) or the user creator, and the intended recipient or a similar intended recipient (e.g., recipient with a similar profile). For example, the relationship indicator may be a number proportional to the influence that the user/creator has over the intended recipient, and may be based on the intended recipient's profile data, social activity/media data, and content specific engagement data (e.g., what type of content the intended recipient is most likely to engage with or be interested in). The relationship indicator may provide insight into how much effort should be expended in customizing the campaign interaction to the particular intended recipient. For example, where an intended recipient has a weaker relationship indicator, steps may be taken to compensate for that weakness, including providing more of an explanation of why a particular campaign interaction would be of interest to the intended recipient. Alternatively, where an intended recipient has a stronger relationship indicator, the campaign interaction may be modified to remind the intended recipient of this strength, thus increasing the likelihood of conversion/traction.

In some embodiments, interaction context may be utilized to further enhance the effectiveness of campaign interactions of a campaign queue, particularly when the campaign interactions are specifically tailored to intended recipients based on the associated interaction context. In this vein, and as described above, the interaction context may also provide a basis for suggestions of how the campaign interactions may be specifically tailored to achieve traction/conversion with the intended recipients.

In some embodiments, interaction history may be used by the machine learning or other predictive algorithms. For example, interaction history may include, for example, the history of interactions (e.g., recent conversations, messages, chats, or emails exchanged, subscription dates, etc.) between the social media account of the user/creator of the campaign queue or campaign interaction and the intended recipient, as well as history of interaction between the intended recipient and the user/creator's related social media account and other marketing channels of the user. By way of illustration, the interaction history for an intended recipient and a user/creator's Facebook® page may include all messages sent to and/or received from the intended recipient by that Facebook® page, as well as all interactions with the intended recipient by way of the user/creator's LinkedIn® page, email addresses, tweets, etc. It may also include ad hoc data unrelated to the user/creator, for example their most recent posts or accounts followed. Interaction history that is related to the user/creator is gathered and stored when a user becomes a member of an audience or segment. Therefore, it is already available before the queue is generated. Ad hoc data may be gathered as the queue is generated, by the system polling data sources for contemporary data that may be helpful, for example a user's latest public posts or photo uploads. Contemporary data is gathered and stored temporarily for as long as the queue is active, and refreshed each time that queue target's information is loaded in the browser window.

Relationship analytics may include a prediction of how likely the campaign interaction is to lead to a “conversion”—e.g., to result in action (e.g., a webpage or social media page/profile visit, share, comment, or another action, depending on the campaign type/goal) by the intended recipient. This prediction may be based on one or more of previous behavior by the intended recipient in similar circumstances, may be extrapolated from previous behavior by the intended recipient in different circumstances (in which case the extrapolation may be based on the difference in the circumstances), may be based on normative/statistical data of similar recipients in similar circumstances, etc. Likewise, the interaction context may include conversion counts and ratios related to the intended recipient (e.g., in previous campaign interactions), as well as other metrics. Likelihood of campaign interaction leading to a conversion is determined by a formula that combines a number of factors, each given proprietary weighting, including the ratio of this recipient's previous conversions to requests relating to this user/creator, the conversion ratio for this type of request, the calculated rate of recent activity of this user on the platform in use, the average time to respond, and predicted share of attention.

### Al-Based Message Templates

In some embodiments, based on one or more campaign setup parameters, the message template may be used by a machine-learning algorithm or model to: provide variations of the same message said in different ways with the same meaning, and incorporate elements of the user's profile.

In some embodiments, a campaign may be optimized with respect to the selected goal by prioritizing the user selection and/or order based on conversion data and campaign settings.

In some embodiments, this may be accomplished by providing the machine learning algorithm with previous campaign data sets upon which it is trained. For example, historical data, comprised of campaign parameters, recipient data and message data, may be combined with result/conversion data to model patterns, add predictions and suggest highest-probability messages in queue for each recipient.

The machine learning algorithm may use the data stored on the server. When a campaign completes, the machine learning algorithm is used on the conversion data to evaluate which messages have been converted and which were not.

In some embodiments, various historical data may be used by the machine learning algorithm when determining one or more parameters that contributed to the success of the campaign. For example, message linguistic content, message length, message format, timing, and recipient biometric information may be evaluated against each other, on an individual, campaign, audience and system-wide levels.

In some embodiments, data related to the recipient and message interaction may be utilized. For example, time, interaction history (e.g., time period of recipient being a follower, time period between engagement), engagement and relationship data, recipient activity data (e.g., how busy is a particular recipient at the time of receipt of message) and similar such data may be used. This data may be obtained and reordered on each level and stored as historical data. When a new campaign is created, and the prioritization or customization machine learning algorithm is used, the components of the new message are evaluated vis-a-vis the stored historical data to date, and the system alongside each message will display options or update to optimize based on updating to maximize effectiveness (for systemwide, audience, campaign and individual).

Various machine learning models may be used. For example, the machine learning models and techniques may include linear regression models, support vector machines (SVM), classifiers, decision trees, neural networks, gradient boosting, and similar machine learning models and techniques. In some embodiments, linear regression models can be used when there is a linear relationship between the input features (e.g., message linguistic content, message length, message format, timing, and recipient biometric information, interaction history, engagement and relationship data, recipient activity data, etc.) and the message content. The model learns the relationship between the data points and predicts the message content based on the input values. Similarly, decision tree-based algorithms, such as Random Forest or Gradient Boosted Trees, can be employed to handle non-linear relationships between the input features and the message content. These models can capture complex interactions and patterns in the data. Further, SVMs can be used to find the hyperplane that best separates the input feature space and predicts the message content. They are effective for both linear and non-linear relationships and can handle high-dimensional feature spaces. Finally, deep learning models, such as Multilayer Perceptrons (MLPs) or Convolutional Neural Networks (CNNs), can be applied to determine the message content. These models can learn complex representations from the input features and have the ability to capture intricate relationships. The machine learning models may be previously trained according to historic correspondences between input historical data and corresponding previously sent messages content. The input parameters may include those described above, for example, these may include message linguistic content, message length, message format, timing, and recipient biometric information, interaction history, engagement and relationship data, recipient activity data.

Once the machine learning models have been trained, new input parameters may be applied to the trained machine learning model as inputs. In response, the machine learning models may provide the messages as outputs.

### Deployment

Deploying the campaign interaction may entail processing the campaign interaction with a series of campaign interactions into a queue such that the entire set of campaign interactions may be deployed nearly simultaneously. Alternatively, each campaign interaction may be deployed in real time upon approval, or may be deployed according to scheduling predetermined by the user (e.g., using the campaign setup parameters described above). In any case, the nature of deploying the campaign interaction may depend on the type of campaign interaction. For example, if the campaign interaction is a Facebook® wall post, deploying the campaign interaction may entail posting the wall post. Or, if the campaign interaction is a message (e.g., email, social media message, or the like), deploying may simply entail sending/transmitting the message to the intended recipient.

Once deployed, the campaign interactions may be tracked such that their reception by the intended recipients may inform future campaigns. For example, and as alluded to above, metrics that may be tracked include conversion (e.g., achievement of or progress toward the campaign goal) and other measurable occurrences.

### Tracking

In some embodiments, campaign tracking component 114 may determine the effectiveness or success of each deployed campaign (e.g., by tracking campaign-related data). For example, that a particular campaign strategy is generally more effective for a given combination of campaign type and campaign goal. The campaign related data includes the desired activity platform, the desired quantity of activities to occur, the timing factors, activity details (if a message, one or more message templates and related data to be incorporated), the intended recipient segment, the goal type and quantity

In some embodiments, tracking component 114 may be configured to automatically track deployed interactions. For example, each campaign, after it is initiated, includes a set of instructions for the system to begin polling for certain types of activities related to the campaign, and on a set schedule. These activities may be available within the data already being tracked by the system (mentions of the user/creator's account on Twitter), or may require using an API to check a data source (e.g., did a specific link get clicked on, when, and how many times each day for a specified number of days after it was generated, and so on).

Such measurable occurrences may include whether the intended recipient clicked on a link included in the campaign interaction; whether the intended recipient subscribed to or unsubscribed from an account that received the campaign interaction; whether the intended recipient mentioned the user/brand or the campaign interaction (e.g., in a social media post); whether the intended recipient attended an event or made a purchase based on the campaign interaction, etc. The tracked results may also be organized and displayed to the user graphically.

Moreover, the tracked results may be presented to the user so as to provide, in addition to the results themselves, insight about the campaign interactions upon which the results are based. For example, the results may include an overall conversion rate for the campaign queue, total clicks generated (where applicable), total number of campaign interactions deployed, the status of the campaign (e.g., active, closed, etc.), a primary type of conversion (e.g., link click), target segments for the campaign and number of individuals in the target segments. The results may also include conversion rates based on the campaign setup parameters, campaign type, campaign goal, campaign strategy, and/or the customization input used for the campaign interactions. By way of illustration, the conversion rates may be provided on a template-by-template basis (e.g., for message templates). An additional aspect of displaying/organizing the results may include a tabular summary of each of the campaign interactions deployed and the results of the deployment. Organized and presented to the user in this manner, the results data may be used to create more effective campaigns going forward.

As alluded to above, the data collected through the above-described tracking of interactions can be stored and processed into a campaign prediction model. For example, the campaign prediction model may be able to use the collected empirical/results data to predict the likelihood that an individual campaign interaction and/or an entire campaign (e.g., one or more campaign queues) will be successful. This prediction for success may be based, by way of illustration, on the campaign goal, the campaign strategy, and/or on the campaign setup parameters. In this context, success may be measured in various ways, including whether a campaign goal is achieved, whether a campaign interaction leads to a conversion, whether a series of campaign interactions achieves a particular conversion rate, and so on.

A successful interaction is one where, as part of a campaign, a recipient was targeted and responded within the campaign parameters or goals. For each specific campaign type, the system may calculate the likelihood of the intended recipient or similar users to different types of content. For example, how likely a user with similar numbers of followers is to follow your account

The tracked data, in another embodiment, may be used to determine whether and the extent to which a campaign has reached a given population of group/segment of people (e.g., within the larger group of intended recipients to whom the campaign was deployed). This determination may be useful because the effect or ultimate return on investment of some campaigns may be based more on the “right” people/recipients (e.g., influential individuals)— rather than a total number of recipients—receiving and responding positively to the campaign.

### Machine Re-Learning

In cases where campaign types determined by campaign type component 108 had a lower likelihood of success than determined inaccurate, the campaign types may in turn be fed back to the model for further relearning and as re-tuning the machine learning model for enhanced accuracy of future predictions. The re-learned model may then be redeployed and utilized again to update and complete the degermation process with enhanced precision.

In some embodiments, determining the extent to which a campaign has penetrated a particular group may also be useful, for example, to ascertain a saturation level of the campaign. Saturation may be determined by selecting an intended audience segment that can be viewed as a group of interest. Then, individual profiles followed by individual members within the group may be compared to a list of profiles that participated in the campaign to date. The profiles that overlap, reveal which members of the group of interest may have seen the campaign. These profiles are then stored as a new audience segment, which is updated regularly until the campaign has completed.

The saturation level may be thought of a point of diminishing return in terms of deploying interactions to a group of people, at which point deploying additional interactions is not likely to yield conversions/success. Alternatively, it may be viewed as an awareness effort, where the goal is to achieve a certain amount of awareness of a message among an intended group.

In this embodiment, the user may select or create a segment/group of interest (e.g., using the interactive display). Based on the tracked data, it may then be determined which intended recipients within that group responded to the campaign interaction deployed. The nature of the individual recipients' responses may also be determined based on the tracked data.

In one example implementation, an additional campaign may be created based on the determination of a previous campaign's penetration level with a group/segment. By way of illustration, it may be determined that a portion of a user-defined group (or segment) has not responded to a deployed campaign. That portion of the group may be analyzed, and a new campaign may be created to target that particular portion, and may be tailored to the individuals in that portion of the original intended recipient pool, including by incorporating their lack of response to the previous campaign. This recursive/adaptive approach to crafting/deploying campaigns not only avoids duplicate efforts to recipients who have responded already, but it also applies a strategic methodology to targeting those individuals that the campaign has not yet reached. In a variation on this implementation, the recursive approach may incorporate the nature of recipients' responses, and not just whether or not the recipients responded to the campaign.

In one embodiment of the system for building a messaging campaign queue with contextualization, the customization input includes modifications to the campaign parameters, modifications to the content of one or more of the campaign interactions, and modifications to deployment timing for one or more of the campaign interactions. In an additional embodiment, the set of campaign parameters includes a campaign goal and a campaign strategy, and the memory module, the computer-executable program code, and the processor are configured to provide a suggestion for one of the campaign goal and the campaign strategy based on the campaign type. The system for building a messaging campaign queue, in one example implementation, involves the memory module, the computer-executable program code, and the processor being configured to receive an instruction via the interactive display. The instruction includes one of the following: to deploy the campaign interaction to the intended recipient, to save the campaign interaction, or to delete the campaign interaction from the campaign queue.

In some instances, features of the above-described embodiments of the system for building a messaging campaign queue may be substantially similar to those described above with reference to FIGS. 1 through 2 (and the accompanying systems, methods, and apparatus). In such instances, the memory module, the computer-executable program code, and the processor may be configured to execute those features. The example computing module may be implemented and may be used to implement the above-described various features in a variety of ways, as described above with reference to FIGS. 1 through 5, and as will be appreciated by one of ordinary skill in the art upon reading the present disclosure.

### Boiler

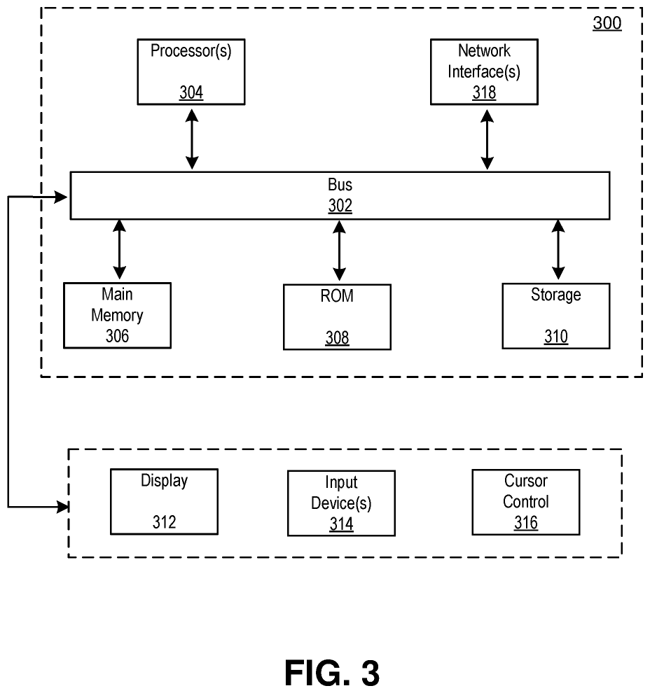

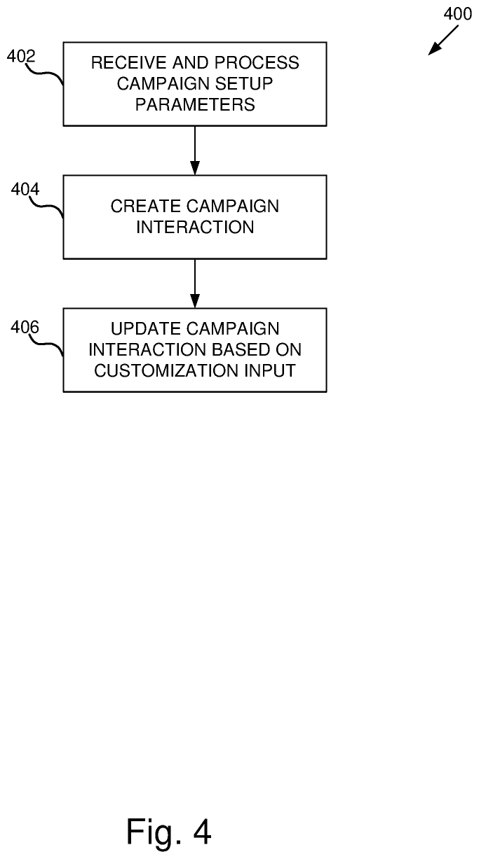

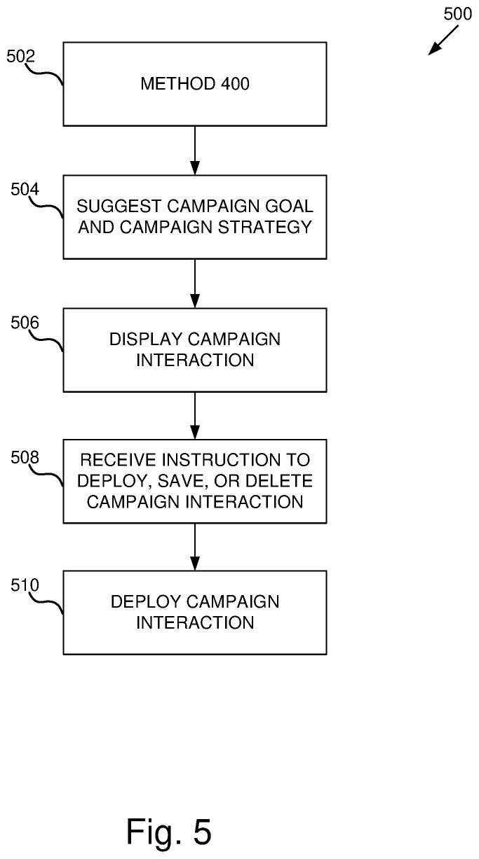

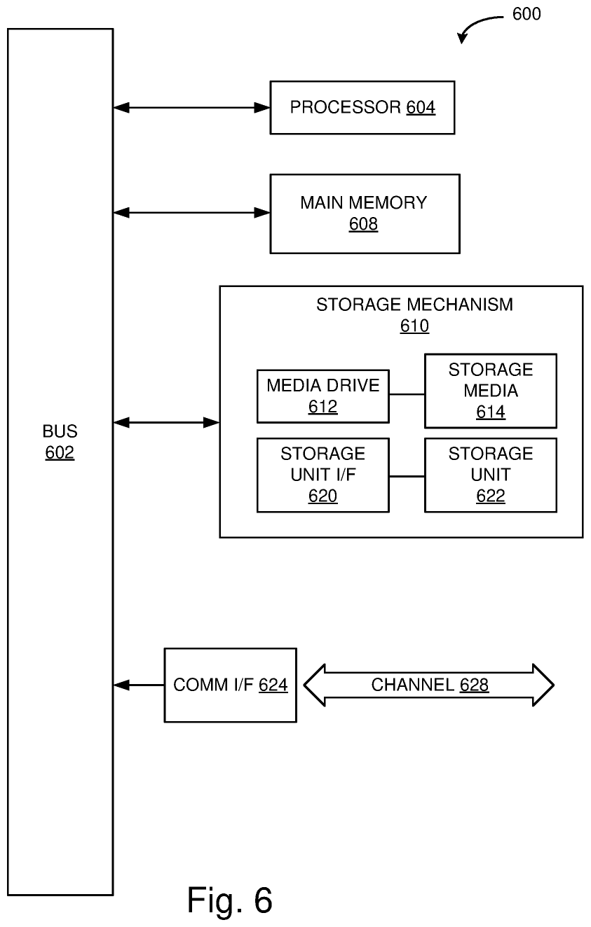

As used herein, the term module may describe a given unit of functionality that can be performed in accordance with one or more embodiments of the present application. As used herein, a module may be implemented utilizing any form of hardware, software, or a combination thereof. For example, one or more processors, controllers, ASICs, PLAs, PALs, CPLDs, FPGAs, logical components, software routines or other mechanisms may be implemented to make up a module. In implementation, the various modules described herein may be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 3. Various embodiments are described in terms of this example computing module 300. After reading this description, it will become apparent to a person skilled in the relevant art how to implement the application using other computing modules or architectures.

FIG. 3 depicts a block diagram of an example computer system 300 in which various of the embodiments described herein may be implemented. The computer system 300 includes a bus 302 or other communication mechanism for communicating information, one or more hardware processors 304 coupled with bus 302 for processing information. Hardware processor(s) 304 may be, for example, one or more general purpose microprocessors.

The computer system 300 also includes a main memory 305, such as a random access memory (RAM), cache and/or other dynamic storage devices, coupled to bus 302 for storing information and instructions to be executed by processor 304. Main memory 305 also may be used for storing temporary variables or other intermediate information during execution of instructions to be executed by processor 304. Such instructions, when stored in storage media accessible to processor 304, render computer system 300 into a special-purpose machine that is customized to perform the operations specified in the instructions.

The computer system 300 further includes a read only memory (ROM) 308 or other static storage device coupled to bus 302 for storing static information and instructions for processor 304. A storage device 310, such as a magnetic disk, optical disk, or USB thumb drive (Flash drive), etc., is provided and coupled to bus 302 for storing information and instructions.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, Javascript, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression, or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor(s) 304 executing one or more sequences of one or more instructions contained in main memory 305. Such instructions may be read into main memory 305 from another storage medium, such as storage device 310. Execution of the sequences of instructions contained in main memory 305 causes processor(s) 304 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 310. Volatile media includes dynamic memory, such as main memory 305. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An apparatus for creating and updating a marketing campaign queue, the apparatus comprising:
a processor;
a memory having computer code being executed to cause the processor to:
obtain a campaign goal, the campaign goal specifying a goal a marketing campaign intends to achieve via a marketing campaign queue, wherein the campaign goal comprises content promotion;
obtain a campaign strategy, the campaign strategy specifying how to achieve the campaign goal for the marketing campaign, wherein the campaign strategy comprises increasing content viewership;
obtain a set of campaign setup parameters, the set of campaign setup parameters specifying at least one of a target segment for the marketing campaign queue, a campaign size, and campaign metadata;
select a campaign type based on the campaign goal and the campaign strategy, the campaign type specifying a type of the marketing campaign, wherein the campaign type comprises a messaging campaign;
determine a set of intended recipients based on the specified target segment;
generate interaction context information for each intended recipient within the set of intended recipients, the interaction context information specifying profile information, interaction history, and relationship analytics;
generate a set of campaign interactions based on the campaign type and the campaign setup parameters for each intended recipient, each of the campaign interactions specifying the interaction context information, wherein the set of campaign parameters are used to facilitate searching, tracking, sorting, and organizing individual campaign interactions within the set of campaign interactions;
estimate a likelihood that the campaign interaction will be successful, wherein the successful campaign interaction results in a user response;
present the set of campaign interaction based on the estimated likelihood of success in a graphical interface of an application via a customization window that presents the customization window for each of the campaign interactions;
update the set of the campaign interactions based on a set of customization parameters; and
transmit approved individual campaign interactions within the set of campaign interactions to the intended recipient;
wherein the approval of the individual campaign interactions is based on the interaction context information performed in the graphical interface of the application via the customization window; and
wherein the set of customization parameters are obtained by way of the customization window of the graphical interface of the application.

2. The apparatus of claim 1, wherein each of the campaign interactions comprises a campaign message; and wherein the computer code being executed to cause the processor to select, on an intended-recipient basis, one or more templates for each of the campaign interactions.

3. The apparatus of claim 2, wherein the computer code being executed to cause the processor to transmit the approved individual campaign interactions further causes the processor to obtain user input and update one or more of the campaign messages based on the user input.

4. The apparatus of claim 2, wherein, for each of the campaign interactions, the messaging setup module suggests one of the templates based on the intended recipient associated with the campaign interaction.

5. The apparatus of claim 1, wherein the customization parameters comprise content of the campaign interaction, timing associated with deployment of the campaign interaction, and a template for the campaign interaction.

6. The apparatus of claim 1, wherein the computer code being executed to cause the processor to transmit approved individual campaign interactions, based on a disposition input received via the customization window, further causes the processor to approve the campaign interaction for deployment to the intended recipient, save the campaign interaction, or remove the intended recipient from the marketing campaign queue.

7. A method for creating and updating campaign interactions, the method comprising:
obtaining a campaign goal, the campaign goal specifying a goal a marketing campaign intends to achieve via a marketing campaign queue, wherein the campaign goal comprises content promotion;
obtaining a campaign strategy, the campaign strategy specifying how to achieve the campaign goal for the marketing campaign, wherein the campaign strategy comprises increasing content viewership;
obtaining and processing a set of campaign setup parameters, the set of campaign setup parameters specifying at least one of a target segment, a campaign size, and campaign metadata;
selecting a campaign type based on the campaign goal and the campaign strategy, the campaign type specifying a type of the marketing campaign, wherein the campaign type comprises a messaging campaign;
determining a set of intended recipients based on the specified target segment;
generating interaction context information for each intended recipient within the set of intended recipients, the interaction context information specifying profile information, interaction history, and relationship analytics;
generating a campaign interaction based on one or more of the campaign type, and the set of campaign setup parameters, wherein the campaign interaction corresponds to one or more intended recipients;
estimating a likelihood that the campaign interaction will be successful, wherein the successful campaign interaction results in a user response;
displaying the campaign interaction based on the estimated likelihood of success and interaction context information associated with the one or more intended recipients in a graphical interface of an application via a customization window that displays the customization window; and
updating the campaign interaction based on customization input specific to one or more of the intended recipients that correspond to the campaign interaction;
wherein the campaign setup parameters are obtained by way of the customization window of the graphical interface of the application.

8. The method of claim 7, wherein the set of campaign setup parameters are configured to facilitate searching, tracking, sorting, and organizing the campaign interaction within a set of campaign interactions.

9. The method of claim 7, wherein the campaign interaction comprises a campaign message comprising a text entry field and one or more tokens.

10. The method of claim 7, wherein the campaign interaction comprises a campaign message; wherein creating the campaign interaction comprises selecting one of a set of campaign message templates; and wherein the campaign message template is selected based on the intended recipient.

11. The method of claim 10, further comprising suggesting one or more of the campaign message templates based on interaction context associated with the one or more intended recipients.

12. The method of claim 7, wherein updating the campaign interaction is done via the graphical user interface; and further comprising deploying the campaign interaction only after the campaign interaction is approved.

13. The method of claim 12, further comprising:
tracking the deployed campaign interaction;
evaluating the intended recipient's reception of the campaign interaction; and
using the evaluated reception to inform a subsequent campaign interaction.

14. The method of claim 7, wherein the interaction context information is configured to facilitate approval of the campaign interaction.

15. A system for building a messaging marketing campaign queue with contextualization, the system comprising:
an interactive display; and
one or more processors configured to:
obtain a campaign goal, the campaign goal specifying a goal a marketing campaign intends to achieve via a marketing campaign queue, wherein the campaign goal comprises content promotion;
obtain a campaign strategy, the campaign strategy specifying how to achieve the campaign goal for the marketing campaign, wherein the campaign strategy comprises increasing content viewership;
obtain a set of campaign parameters, the set of campaign parameters specifying at least one of a target segment for the marketing campaign queue, a campaign size, and campaign metadata;
select a campaign type based on the campaign goal and the campaign strategy, the campaign type specifying a type of the marketing campaign, wherein the campaign type comprises a messaging campaign;
determine a set of intended recipients based on the specified target segment;
generate interaction context information for each intended recipient within the set of intended recipients, the interaction context information specifying profile information, interaction history, and relationship analytics;
determine a likelihood that the campaign interaction will be successful, wherein the successful campaign interaction results in a user response;
create a campaign queue based on the campaign type and the set of campaign parameters, the campaign queue comprising a set of campaign interactions based on the estimated likelihood of success, each of the campaign interactions associated with each intended recipient;
provide, via the interactive display, interaction context information associated with one or more of the campaign interactions; and
customize one or more of the campaign interactions based on customization input received via the interactive display;
wherein the customization input is obtained by way of the interactive display.

16. The system of claim 15, wherein the one or more processors are further configured to provide a suggestion for one of the campaign goal and the campaign strategy based on the campaign type.

17. The system of claim 15, wherein the customization input comprises a modification to the campaign parameters, a modification to content of one or more of the campaign interactions, and a modification to deployment timing for one or more of the campaign interactions.

18. The system of claim 15, wherein the one or more processors are further configured to, for each of the one or more campaign interactions, receive an instruction to:
deploy the campaign interaction to the intended recipient;
save the campaign interaction; or
delete the campaign interaction from the campaign queue;
wherein the instruction is received via the interactive.
